(19) United States
(12) Patent Application Publication
(10) Pub. No.: US 2025/0198013 A1
(43) Pub. Date: Jun. 19, 2025

(54) METHOD OF PREPARING HYDROGEN BASED ON MICRO-DROPLETS

(71) Applicant: XI'AN UNIVERSITY, XI'AN (CN)

(72) Inventors: KAI LUO, XI'AN (CN); ZI-ANG NAN, XIAMEN (CN)

(21) Appl. No.: 19/071,272

(22) Filed: Mar. 5, 2025

Related U.S. Application Data
(63) Continuation of application No. PCT/CN2022/126964, filed on Oct. 24, 2022.

(30) Foreign Application Priority Data
Oct. 18, 2022 (CN) 202211273388.3

(51) Int. Cl. C25B 1/04; C25B 9/67; C25B 11/048; C25B 15/08

(52) U.S. Cl. CPC C25B 1/04; C25B 9/67; C25B 11/048; C25B 15/08

(57) ABSTRACT

A method of preparing hydrogen based on micro-droplets includes: S1, mixing water and a regulator to obtain an aqueous solution, where the regulator is one or more of: a metal conductor, a nanomaterial, a conductive polymer, and an inorganic salt having a redox property; S2, inputting the aqueous solution to a micro-droplet generation device to generate the micro-droplets, where each of the micro-droplets has a size of less than or equal to 10 μm, and hydrogen radicals are spontaneously generated at a gas-liquid interface of each of the micro-droplets; S3, the hydrogen radicals being compounded with each other to generate the hydrogen; and S4, collecting the hydrogen or the hydrogen radicals.

### FIELD

The present disclosure relates to the technical field of green energies, and particularly to a method for preparing hydrogen based on micro-droplets.

### BACKGROUND

Energy problems is one of major problems confronted by the human society. Shortage of energies, as well as energy crisis, seriously constrains development of the human society. Looking for an alternative green energy has become a research hotspot in the fields of energies. As the zero-carbon energy source, more and more attention has payed to hydrogen energy globally. Due to high efficiency and cleanliness of hydrogen energy, it is considered as one of most promising energy sources in the future. With the aim of achieving Carbon Peak in 2030 and Carbon neutrality in 2060, an annual demand of hydrogen in China may reach 37.15 million tons and 130 million tons, separately. Hydrogen produced by splitting water using renewable energy, where the combustion process only generates water, achieves zero carbon dioxide emissions at the source, making it truly a green new energy (green hydrogen). Exploring methods and related processes for efficient water splitting to produce hydrogen has become a research hotspot in the field of energy.

Currently, hydrogen production technology mainly features photocatalysis, utilizing photocatalytic technology to produce hydrogen. In the above process, acetic acid is used as a sacrificial agent with high cost. For some other technologies, the water is decomposed to obtain and separate the hydrogen based on a photocatalytic fuel cell technology in which a hydrogen fuel cell inverse principle is applied. The hydrogen and the oxygen are produced at the cathode and anode, separately with transferring protons or hydroxide ion under light radiation with ionic membrane. However, it is confined by the complex separation device and cost catalysts.

It is to be noted that, information disclosed in the background section in the above is provided to only facilitate understanding of the present disclosure, and therefore, information that does not constitute the related art known to any ordinary skilled person in the art may be included.

### SUMMARY

A method of preparing the hydrogen based on micro-droplets is provided in the present disclosure, solving the technical problem of the high preparation cost and the structurally complex separation device during preparing the hydrogen.

A method of preparing hydrogen based on micro-droplets is provided and includes:
S1, Mixing the regulator in water to obtain an aqueous solution, where the regulator is one or more of: a metal conductor, a nanomaterial, a conductive polymer, and an inorganic salt with the redox property;
S2, inputting the aqueous solution to a micro-droplet generation device for generating the micro-droplets, where each of the micro-droplets has a size of less than or equal to 10 μm, and the hydrogen radicals are spontaneously generated at a gas-liquid interface of each of the micro-droplets;
S3, the hydrogen radicals being compounded with each other to generate the hydrogen; and
S4, collecting the hydrogen or the hydrogen radicals.

In some embodiments, the micro-droplet generation device is one of: an electrospray device, a pneumatic spray device and an ultrasonic atomization device.

In some embodiments, the inorganic salt is one or more of: chloroauric acid (HAuCl₄), palladium chloride (PdCl₂) and chloroauric acid-palladium chloride (HAuCl₄—PdCl₂); the nanomaterial is one or more of: gold nanoparticles, palladium-coated gold nanoparticles, and gold-palladium alloy nanoparticles; the conductive polymer is one or more of: C₆₀—(OH)n, an alkalized polyaniline-gold nanoparticle complex, and an acidified polyaniline-gold nanoparticle complex.

In some embodiments, when the regulator is the inorganic salt, a concentration of the inorganic salt in the aqueous solution is 50 to 1000 μg/mL; when the regulator is the nanomaterial or the conductive polymer, a concentration of the nanomaterial or the conductive polymer in the aqueous solution is 10⁻⁵ to 10⁻¹ mg/mL.

In some embodiments, the micro-droplet generation device is an electrospray device, the electrospray device has an electrospray probe; the aqueous solution is inputted into the electrospray probe with a flow rate of 5 to 150 μL/min; the electrospray probe has an inner diameter of 5 to 150 μm, and a bias voltage of 3 to 7 kV is applied at the electrospray probe.

In some embodiments, the step of collecting the hydrogen or the hydrogen radicals includes:
arranging a collection device at a spray end of the micro-droplet generation device, where the collection device has a closed collection chamber and an outlet pipeline communicated with the collection chamber; and
the spray end of the micro-droplet generation device extending into the collection chamber to enable the generated hydrogen to flow through the collection chamber to enter the outlet pipeline.

In some embodiments, a refrigerant is arranged at an outside of the collection chamber to cool and solidify water formed during a spraying process; and the refrigerant is one or more of: liquid nitrogen, ice water, ice-containing saline and ethylene glycol.

In some embodiments, a conductive polymer plate is arranged inside the collection chamber; the conductive polymer plate is grounded or connected to a high voltage, a polarity of the high voltage is opposite to the voltage applied to the micro-droplet generation device.

In some embodiments, the collection chamber is connected with to an inlet pipeline, a carrier gas is input to the collection chamber through the inlet pipeline and carry the hydrogen out of the collection chamber from outlet pipeline.

In some embodiments, the step of collecting the hydrogen or the hydrogen radicals includes:
arranging a radical capturing device at a spray end of the micro-droplet generation device, the radical is captured by the radical capturing agent at the surface of the large droplet; and
applying a voltage, which has an opposite polarity voltage to the micro-droplet generation device, and the hydrogen radicals are captured during the process of flying to to the large droplets of the radical capturing device.

For the method of preparing the hydrogen provided in the present disclosure, the micro-droplets with the diameter of less than 10 μm, are obtained by a micro-droplet generation device. The micro-droplets have a “confined effect” in the meso-scale with special physicochemical properties, such as high specific surface area, abundant charge density, and strong electric field of the electric double layer, etc. Especially, microdroplets as microreactors, it could utilize unique gas-liquid interface effects and the strong electric field of the electrical double layer (10⁷ V/cm) to generate hydrogen radicals from the ionization of water molecules (H⁺) and the formation of hydrogen radicals (·H, H⁺+e⁻→·H), and eventually form the hydrogen under the transient recombination of radical reaction (2·H→H₂).

However, each of the hydrogen radicals has a relatively short half-life (<10⁻⁹ s), and hydrogen ions can be transiently formed due to a reversed process (·H−e⁻→H⁺). The reversed process is controlled by whether electron (e⁻) are transferred. The electrons (e⁻) generated at the interface can be transferred based on electron transfer properties of metal conductive materials, nanomaterials, inorganic salts and other regulators, and therefore, reactions can occur forwardly only. The hydrogen radicals (·H, H⁺+e⁻→·H) are accumulated at the gas-liquid interface and are compounded with each other to form the hydrogen (H₂). In this way, the hydrogen is prepared highly efficiently and spontaneously, and therefore, a green, efficient, and economically-saving method of preparing green hydrogen is provided.

For method of preparing the hydrogen, the water is used as a raw material, and the efficiency of hydrogen generation is greatly improved by using the regulators. The efficiency of hydrogen preparation can reach 113,400 μmol/g·h. No catalyst is needed, and some regulators can be recycled and reused. Making it environmentally friendly. It is not limited by geography or integrated equipment, and the production cost is controllable, meeting the production needs of various processes.

It is understood that the above general description and detailed description in the following are only exemplary and explanatory and shall not limit the present disclosure.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is a flow chart of a method of preparing hydrogen based on micro-droplets according to an embodiment of the present disclosure.

FIG. 2 is a structural view of a micro-droplet generation device and a radical capturing device according to an embodiment of the present disclosure.

FIG. 3 is a structural view of a collection device and a mass spectrometer according to an embodiment of the present disclosure.

FIG. 4 is a structural view of the collection device according to another embodiment of the present disclosure.

FIG. 5 shows an electron paramagnetic resonance (EPR) spectrum diagram of DMPO solution capturing hydrogen radicals in micro-droplets formed from various aqueous solutions according to an embodiment 1 of the present disclosure.

FIG. 6 shows mass spectrometer diagrams of hydrogen prepared based on micro-droplets formed from various aqueous solutions according to an embodiment 2 of the present disclosure.

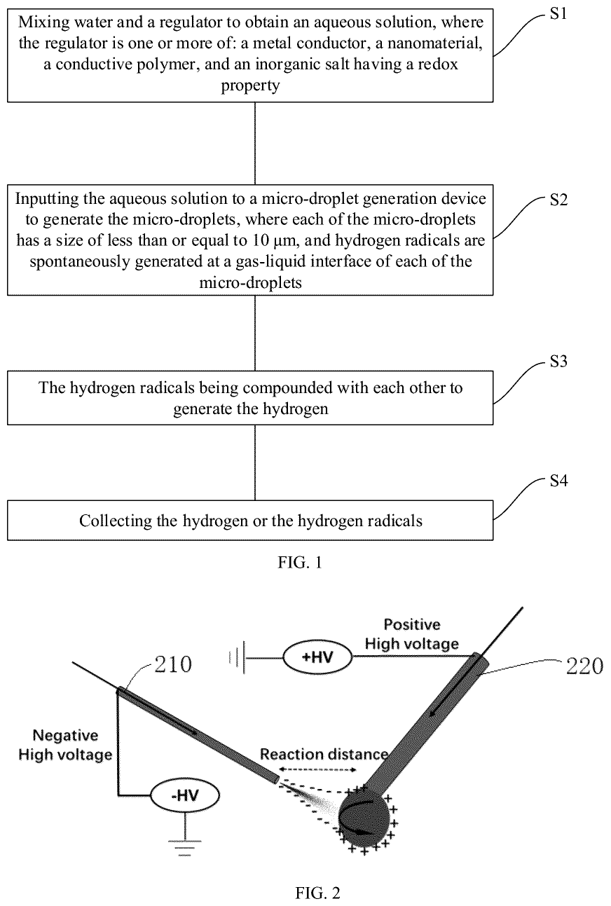

### DETAILED DESCRIPTION

In order to facilitate the understanding of the present disclosure, a more comprehensive description of the present disclosure will be made hereinafter with reference to relevant drawings. Operations in the embodiments that are not specified with detailed conditions are performed based on conventional conditions or conditions recommended by a manufacturer. A reagent or a device used in the operations that is not indicated with any manufacturer can be any conventional and commercially available reagent or device.

The method of preparing hydrogen based on micro-droplets will be specifically described below.

In a step S1, Mixing a regulator in water to obtain an aqueous solution, where the regulator is one or more of: a metal conductor, a nanomaterial, a conductive polymer, and an inorganic salt with the redox property.

In a step S2, inputting the aqueous solution to a micro-droplet generation device for generating the micro-droplets, where each of the micro-droplets has a size of less than or equal to 10 μm, and hydrogen radicals are spontaneously generated at a gas-liquid interface of each of the micro-droplets.

In a step S3, the hydrogen radicals being compounded with each other to generate the hydrogen; and

In a step S4, collecting the hydrogen or the hydrogen radicals

For the above method of preparing the hydrogen, by using the specific regulator, an electronic conductor is introduced into each of the micro-droplets that serves as a microreactor, a thickness of a dielectric double layer or conductivity performance is selectively regulated, an electron stripping efficiency is improved, inducing the hydrogen radicals to be compounded with each other to be converted in the hydrogen. This method of hydrogen production introduces an electronic conductor into micro-droplets used as microreactors. It could selectively adjusting the thickness of the electrical double layer or the conductive properties through specific modulators, and enhancing the efficiency of electron stripping, promoting the mutual combination of hydrogen radicals, and thus converting them into hydrogen gas.

In an embodiment of the present disclosure, the inorganic salt is one or more of: chloroauric acid (HAuCl₄), palladium chloride (PdCl₂) and chloroauric acid-palladium chloride (HAuCl₄—PdCl₂). Performance of redox property of the gas-liquid interface of each of the micro-droplets is improved, and enhanced the efficiency of hydrogen generation.

In an embodiment of the present disclosure, the nanomaterial is one or more of: (Au NPs), palladium-coated gold nanoparticles (Au@Pd NPs), and gold-palladium alloy nanoparticles (AuPd alloy NPs). The conductive polymer is one or more of: C60-(OH)n, an alkalized polyaniline-gold nanoparticle complex (PANI@AuNPs-NaOH), and acidified polyaniline-gold nanoparticle complex (PANI@AuNPs-HCl). By adding the above nanoparticles, the generation of hydrogen is promoted by enhancing an interfacial effect of microdroplet, regulating the thickness of the dielectric double layer, changing the efficiecny of the electron stripping efficiency.

Specifically, C₆₀—(OH)n is a polyhydroxy compound of C₆₀, named as fullerol. The fullerol is soluble in water with a plurality of hydroxyl group, which can be synthesized by amine-catalyzation. The ANI@AuNPs-NaOH and the PANI@AuNPs-HCl can be obtained according to preparation methods available in the related art. For example, in an embodiment, 3.5 mL of 55 nm gold nanoparticles are dispersed in a solution of 1.5 mL of 2 mM aniline and 0.25 mL of 40 mM SDS. The above solution is vortexed on a vortex mixer for 1 min. An aqueous solution containing 1.5 mL of 2 mM of (NH₄)₂S₂O₈—HCl is added in the vortexed solution and is further vortexed for 10 s. After a reaction of 12 h at an ambient temperature, aniline in the solution is polymerized to encapsulate the surface of the gold nanoparticles to obtain a ANI-AuNPs with a thickness of about 16 nm. The gold nanoparticle aqueous solution is centrifuged to discharge a supernatant and rinse a precipitation to obtain PANIAuNPs-HCl. The PANI@AuNPs-HCl particles are dispersed in water to obtain a PANI@AuNPs-HCl aqueous solution, a 2 M NaOH solution is added to the PANI@AuNPs-HCl aqueous solution to adjust a pH value of the PANI@AuNPs-HCl aqueous solution to reach 11.4, the PANI@AuNPs-HCl aqueous solution with the 2 M NaOH solution is magnetically stirred for 2 h to obtain PANI@AuNPs-NaOH.

In an embodiment of the present disclosure, when the regulator is the inorganic salt, a concentration of the inorganic salt in the aqueous solution is 50 to 1000 μg/mL. When the regulator is the nanomaterial or the conductive polymer, a concentration of the nanomaterial or the conductive polymer in the aqueous solution is 10⁻⁵ to 10⁻¹ mg/mL. By adding regulators of various concentrations, various concentration of hydrogen may be generated from the reaction system.

Further, in an embodiment of the present disclosure, the regulator is HAuCl₄, PdCl₂, or HAuCl₄—PdCl₂ with concentration of 500 μg/mL. At the concentration of 500 μg/mL, a yield of the hydrogen reaches 13,200 μmol/g·h or more for HAuCl₄—PdCl₂. Further, when the regulator is AuPd alloy NPs with a concentration of 10⁻² mg/mL, and at the concentration of 10⁻² mg/mL, the yield of the hydrogen reaches more than 113,400 μmol/g·h for AuPd alloy. The reason for different hydrogen generation efficiencies are summarized as following: for nano AuPd alloys, the higher of hydrogen generation efficiency is based on excellent electron stripping performance, which promoting the hydrogen radicals (H) to be compounded with each other to generate more hydrogen. But for the inorganic salt, it not only serves as a sacrificial agent for hydrogen generation, but also a redox reaction between the hydrogen radicals and the inorganic salt is caused (3·H+HAuCl₄→Au+4HCl, 2·H+PdCl₂→Pd+2HCl), where hydrogen radicals (·H) are consumed.

In an embodiment of the present disclosure, the micro-droplet generation device is one of: an electrospray device, a pneumatic spray device and an ultrasonic atomization device. Specific constructions of the electrospray device, the pneumatic spray device and the ultrasonic atomization are available in the related art. For example, a specific construction of the electrospray device may be referred to an electrospray device in a mass spectrometry analysis technique.

In an embodiment, the electrospray device includes a syringe, a connector, an electrospray probe and a high voltage power supply. The connector may be, such as, a two-way connector. The syringe and the electrospray probe are connected via the connector, and the aqueous solution was inputted into the electrospray probe through the syringe. An electric field force is formed under the control of a high voltage electric field at a spraying end of the electrospray probe, which induce the aqueous solution is atomized to form the micro-droplets based on the theory of electro-hydro-dynamics.

In an embodiment, the pneumatic spraying device includes a syringe, a Tee connector, a capillary tube and a gas cylinder. The syringe and the capillary tube are respectively connected to two ends of the Tee connector, and the rest end of the Tee connector is connected to the gas cylinder, and sheathed gases at different pressures are adjusted. A spray probe is formed at an output end of the capillary tube, and the aqueous solution enters the capillary tube through the syringe and forms, due to pneumatic atomization, the micro-droplets at an end of the spray probe.

In an embodiment, the ultrasonic atomization device includes a syringe, an ultrasonic generator device and a spray head. The ultrasonic generator generates an ultrasonic shock wave energy, and the aqueous solution is atomized by the ultrasonic shock wave energy to form the micro-droplets.

In an embodiment of the present disclosure, the micro-droplet generation device is the electrospray device, the electrospray device has an electrospray probe. The aqueous solution is inputted into the electrospray probe with a flow rate of 5-150 μL/min. The electrospray probe has an inner diameter of 5-150 μm with applying of a bias voltage of 3-7 kV. Especially, the flow rate at the electrospray probe is 10 μL/min, the electrospray probe has the inner diameter of 50 μm. With above preparation parameters, an efficiency rate of hydrogen generation via micro-droplet reaction can be increased.

In an embodiment of the present disclosure, the step S4, in which the hydrogen radicals are collected, includes following steps.

A radical capturing device is arranged at a spray end of the micro-droplet generation device, the radical capturing agent is set to capturing the hydrogen radicals in the large droplets from the radical capturing device.

A voltage, which has an opposite polarity to the micro-droplet generation device, is applied at an output end of the radical capturing device to cause the micro-droplets to move towards the large droplets to capture the hydrogen radicals generated from the micro-droplets.

Specifically, FIG. 2 is a structural view of the radical capturing device according to an embodiment of the present disclosure. As shown in FIG. 2, the micro-droplet generation device is the electrospray device, a negative high voltage is applied to an electrospray probe 210 to generating the microdroplet via the tip of electrospray probe. The radical capturing device is composed of a quartz capillary 220 with a large inner diameter. The radical capturing agent is input through a syringe pump (not shown), and a positive high voltage is applied to the quartz capillary 220 to generate the large droplets with opposite polarity. Under the adjustment of strong electric field, the micro-droplets formed from electrospray probe fly towards and softly land on surfaces of the large droplets, which is rotating at a high speed. The hydrogen radicals (·H) formed in the microdroplet are captured by the radical capturing agent and collected.

Specifically, the radical capturing agent is a type of light stabilizers of piperidine derivatives with spatial site resistance, such as salicylates, benzophenones, benzotriazoles, substituted acrylonitriles, triazines, and so on. The radical capturing agent in the embodiments of the present disclosure is an aqueous solution of DMPO (5,5-dimethyl-1-pyrroline-N-oxide). Further, the quartz capillary 220 with the inner diameter of 140 to 300 μm form the larger droplets to easily collect the hydrogen radicals.

In an embodiment of the present disclosure, the step S4, in which the hydrogen is collected, includes following operations.

A collection device is arranged at the spray end of the micro-droplet generation device, the collection device has a closed collection chamber and an outlet pipeline communicated with the collection chamber.

The spray end of the micro-droplet generation device extends into the collection chamber to enable the generated hydrogen to flow through the collection chamber to enter the outlet pipeline.

Further, in an embodiment of the present disclosure, a refrigerant is arranged at an outside of the collection chamber to cool and solidify water formed during a spraying process. The refrigerant is one or more of: liquid nitrogen, ice water, ice-containing saline and ethylene glycol. By arranging the refrigerant, the hydrogen generation efficiency can be effectively promoted.

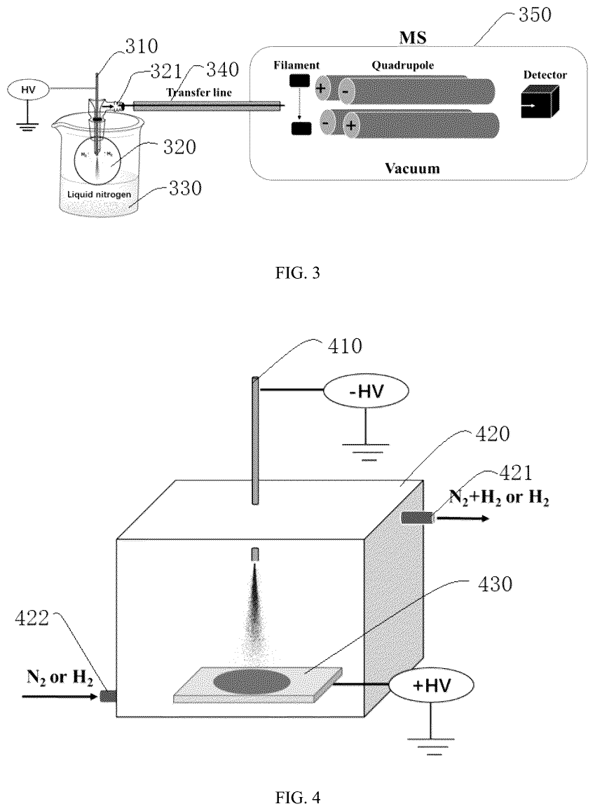

Specifically, FIG. 3 schematically shows a structural view of the collection device according to an embodiment of the present disclosure. As shown in FIG. 3, the collection device has the closed collection chamber 320, and the electrospray probe 310 of the micro-droplet generation device (electrospray device) extends into the collection chamber 320. The collection chamber 320 can be obtained, for example, from a round-bottomed flask. The collection chamber 320 has an outlet pipeline 321, the outlet pipeline 321 is configured to export the hydrogen in the collection chamber. The collection chamber 320 is located in a refrigeration chamber 330, and the refrigeration chamber 330 is filled with the refrigerant (such as the liquid nitrogen). In this way, a cold trap system is formed to cool and solidify the water formed during the spraying process.

Further, in an embodiment of the present disclosure, the hydrogen generated by the electrospray probe 310 in the collection chamber 320 flows through the outlet pipeline 321 to enter a transfer pipeline 340. The hydrogen is input into a mass spectrometry detector 350 via the transfer pipeline 340 and is on-line detected and analyzed by mass spectrometry.

In an embodiment of the present disclosure, the collection chamber of the collection device is arranged with a conductive polymer plate. The conductive polymer plate is grounded or connected to a high voltage with the opposite polarity to the micro-droplet generation device. Specifically, the conductive polymer plate may be, for example, a dense and porous polyaniline laminate, and a thickness of the polyaniline laminate may be 0.5 to 2 cm. By arranging the conductive polymer plate, on the one hand, to promote the hydrogen generation by removing excessive electric charges; and on the other hand, to collect and recycle the regulator in the microdroplet by the way of soft landing of the micro-droplets.

In an embodiment of the present disclosure, the collection chamber of the collection device is further connect with an inlet and outlet pipeline, a carrier gas is input to the collection chamber through the inlet pipeline to drive the generated hydrogen to be output from the outlet pipeline. Specifically, the carrier gas may be, for example, hydrogen, argon or a mixture of the hydrogen and the argon.

Specifically, FIG. 4 schematically shows the structural view of the collection device in another embodiment of the present disclosure. As shown in FIG. 4, the collection device has the closed collection chamber 420, and the electrospray probe 410 of the micro-droplet generation device (electrospray device) insert into the collection chamber 420. The collection chamber 420 can be obtained, for example, by a sealed box. The collection chamber 420 has an outlet pipeline 421 and an inlet pipeline 422, the outlet pipeline 421 is disposed at an upper right side of the collection chamber 420, and the inlet pipeline 422 is disposed at a lower left side of the collection chamber 420. The carrier gas is inputted through the inlet pipeline 422 to drive the hydrogen to be output from the outlet pipeline 421. A polyaniline laminate 430 is arranged in the collection chamber 420. The polyaniline laminate 430 is disposed below the electrospray probe 410 and is connected to a high voltage with the opposite polarity to the electrospray probe 410.

Features and performance of the present disclosure are described in further detail below by referring to embodiments.

### Embodiment 1

The present embodiment provides a method of preparing the hydrogen, and the hydrogen is collected by the micro-droplet generation device and the radical capturing device as shown in FIG. 2. Details are as follows.

(1) Aqueous solutions are prepared. An aqueous solution of a is the aqueous solution of HAuCl₄ with the concentration of 50 μg/mL; and an aqueous solution of b is the aqueous solution of PdCl₂ with the concentration of 50 μg/mL, an aqueous solution of c is the aqueous solution of HAuCl₄—PdCl₂ with the concentration of 50 μg/mL, and an aqueous solution of d is the aqueous solution of AuPd alloy NPs with the concentration of 5 μg/mL.

(2) The aqueous solution of a, b, c, and d are inported into the micro-droplet generation device to generate the micro-droplets. The inner diameter of the electrospray probe, serving as the micro-droplet generation device, is 50 μm with the flow rate of 10 μL/min, and an electrospray bias voltage is −6.3 kV.

(3) A DMPO solution with the concentration of 200 μg/mL is inported into the quartz capillary 220 of the radical capturing device to generate the large droplets. The inner diameter of the quartz capillary 220 is 150 μm with the flow rate of 10 μL/min, and a bias voltage of +3 kV is applied.

(4) Negatively-charged micro-droplets fly toward positively-charged large droplets that are rotating at a high speed to form the droplet soft landing. During this process, the hydrogen radicals (·H) formed in the microdroplet, are captured by DMPO in the large droplet. Ultimately, the large droplet are collected and detected.

FIG. 5 shows an electron paramagnetic resonance (EPR) spectrum diagram of the hydrogen radicals, which are formed from the regulator solution of a, b, c, d, and pure water, captured by the DMPO solution. As shown in FIG. 5, five characteristic peaks of a DMPO-H adduct formed by hydroxyl radicals (H) captured by the DMPO solution in the range of 3320-3420, where gᵢₛₒ=2.0057, aᵢₛₒ(¹⁴N)=1.64 mT (×1) and aᵢₛₒ(¹H)=2.25 mT (×2). In the EPR spectrum, reactive oxygen radicals (·OH and ·OOH) are simultaneously captured by the DMPO solution to form four characteristic peaks of the DMPO-H adduct, where gᵢₛₒ=2.0057, aᵢₛₒ(¹⁴N)=1.48 mT (×1) and aᵢₛₒ(¹H)=1.48 mT (×1). As the control sample, the corresponding characteristic peaks of the pure water are weaker.

### Embodiment 2

The present embodiment provides a method of preparing the hydrogen, and the hydrogen is online detected and analyzed by a mass spectrometer 350 as shown in FIG. 3. Details are as follows.

(1) Aqueous solutions are prepared. The aqueous solution of a is the aqueous solution of HAuCl₄ with the concentration of 500 μg/mL; and the aqueous solution of b is the aqueous solution of PdCl₂ with the concentration of 500 μg/mL, the aqueous solution of c is the aqueous solution of HAuCl₄—PdCl₂ with the concentration of 500 g/mL, and the aqueous solution of d is the aqueous solution of AuPd alloy NPs with the concentration of 50 μg/mL.

(2) The aqueous solution a, b, c, and d are imported into the micro-droplet generation device to generate the micro-droplets. The inner diameter of the electrospray probe, serving as the micro-droplet generation device, is 50 μm with the flow rate of 10 μL/min, and the electrospray bias voltage is −3 kV.

(3) The hydrogen generated at the gas-liquid interface of the micro-droplets are on-line detected and analyzed by the mass spectrometer 350 through the transfer pipeline 340.

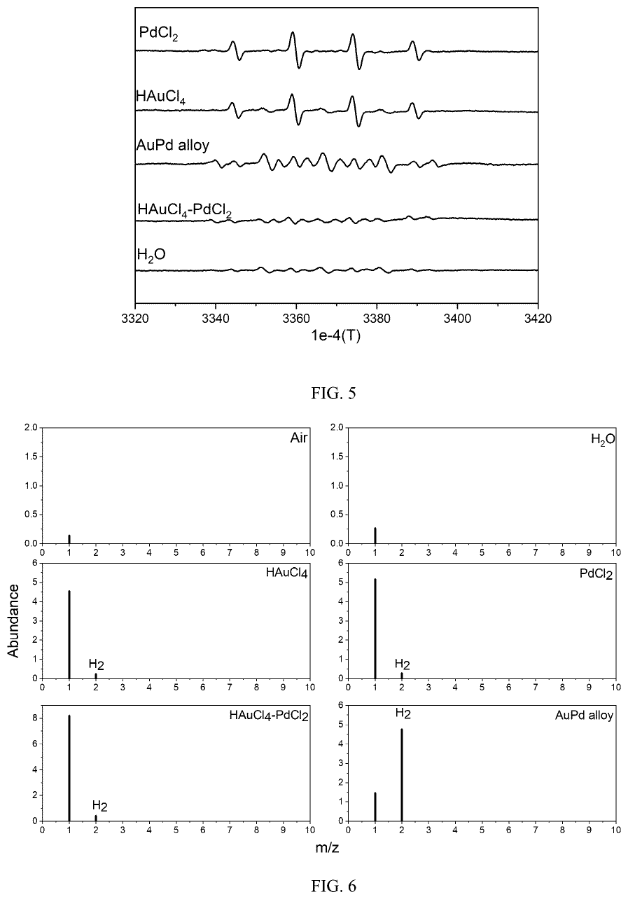

FIG. 6 shows mass spectrometer diagrams of the hydrogen prepared based on the hydrogen radicals (·H) formed from the aqueous solution a, b, c, d, and the pure water. As shown in FIG. 6, no hydrogen is detected for the micro-droplets from the pure water. The characteristic peaks of the hydrogen at m/z of 2, which is denote of hydrogen, is detected from the aqueous solution of a, b, c, and d micro-droplets with the different abundance respectively. Obviously, the aqueous solution of d microdroplet reaction have the strongest abundance for hydrogen.

### Embodiment 3

The present embodiment provides a method of preparing the hydrogen, and the hydrogen is collected by the collection device shown in FIG. 4. Details are as follows.

(1) Aqueous solutions are prepared. The aqueous solution of a is the aqueous solution of HAuCl₄ with the concentration of 500 μg/mL; and the aqueous solution of b is the aqueous solution of PdCl₂ with the concentration of 500 μg/mL, the aqueous solution of c is the aqueous solution of HAuCl₄—PdCl₂ with the concentration of 500 g/mL, and the aqueous solution of d is the aqueous solution of AuPd alloy NPs with the concentration of 10⁻² mg/mL.

(2) The aqueous solution of a, b, c, and d are imported d into the micro-droplet generation device to generate the micro-droplets. The inner diameter of the electrospray probe 410, serving as the micro-droplet generation device, is 50 μm with the flow rate of 10 μL/min, and the electrospray bias voltage is −3 kV. A distance of an end of the electrospray probe 410 to the polyaniline laminate 430 disposed below is 3 cm.

(3) Argon at a certain flow rate is imported as the carrier gas at the lower left of the collection chamber 420, and the hydrogen in the collection chamber 420 is carried out through the outlet pipeline 421 at the upper right.

After spraying for 60 min, the collected hydrogen is detected. Results of mass spectrometry detection are consistent with results of the hydrogen peaks in the Embodiment 2. Hydrogen production capacities of the micro-droplets are shown formed from the aqueous solution a, the aqueous solution b, the aqueous solution c, and the aqueous solution d are shown in Table 1 below for the aqueous solution of a, b, c, and d, respectively.

TABLE 1

| | | H₂ yield |
|---|---|---|
| Regulator | concentration | (μmol/g · h) |

| | | | |
|---|---|---|---|
| HAuCl₄ | 500 | μg/mL | 13200 |
| PdCl₂ | 500 | μg/mL | 14400 |
| HAuCl₄—PdCl₂ | 500 | μg/mL | 19200 |
| AuPd alloy | 10⁻² | mg/mL | 113400 |

| | | |
|---|---|---|
| H₂O | — | Not detected |

As shown in Table 1, for the method of preparing the hydrogen provided in the present disclosure, the amount of generated hydrogen is greatly improved by adding different regulators. The hydrogen generated in the pure water micro-droplets is extremely low and is barely detected. For the inorganic salt chloroauric acid-palladium chloride (500 μg/mL), a maximum of 19,200 μmol/g·h of hydrogen is prepared. For the 10⁻² mg/mL of AuPd alloy, a maximum of 113,400 μmol/g·h of hydrogen is prepared and is 5.9 times of chloroauric acid-palladium chloride. Therefore, the method of the present application is highly practically, providing support for generating the hydrogen from the perspectives of environmental protection and economic saving, and therefore, the method is a strong solution for both reaching the carbon peak and carbon neutralization.

The embodiments described above show only some of, but not all of, the embodiments of the present disclosure. Detailed description of the embodiments of the present disclosure is not intended to limit the scope of the present disclosure, but merely indicates selected embodiments of the present disclosure. All other embodiments, which are obtained by any ordinary skilled person in the art based on the embodiments of the present disclosure without creative work, shall fall within the scope of the present disclosure.

What is claimed is:

1. A method of preparing hydrogen based on micro-droplets, comprising:
S1, mixing water and a regulator to obtain an aqueous solution, wherein the regulator is one or more of: a metal conductor, a nanomaterial, a conductive polymer, and an inorganic salt having a redox property;
S2, inputting the aqueous solution to a micro-droplet generation device to generate the micro-droplets, wherein each of the micro-droplets has a size of less than or equal to 10 μm, and hydrogen radicals are spontaneously generated at a gas-liquid interface of each of the micro-droplets;
S3, the hydrogen radicals being compounded with each other to generate the hydrogen; and
S4, collecting the hydrogen or the hydrogen radicals.

2. The method according to claim 1, wherein the micro-droplet generation device is one of: an electrospray device, a pneumatic spray device and an ultrasonic atomization device.

3. The method according to claim 1, wherein the inorganic salt is one or more of: chloroauric acid (HAuCl₄), palladium chloride (PdCl₂) and chloroauric acid-palladium chloride (HAuCl₄—PdCl₂); the nanomaterial is one or more of: gold nanoparticles, palladium-coated gold nanoparticles, and gold-palladium alloy nanoparticles; the conductive polymer is one or more of: C₆₀—(OH)n, an alkalized polyaniline-gold nanoparticle complex, and an acidified polyaniline-gold nanoparticle complex.

4. The method according to claim 1, wherein when the regulator is the inorganic salt, a concentration of the inorganic salt in the aqueous solution is 50 to 1000 μg/mL; when the regulator is the nanomaterial or the conductive polymer, a concentration of the nanomaterial or the conductive polymer in the aqueous solution is 10⁻⁵ to 10⁻¹ mg/mL.

5. The method according to claim 1, wherein the micro-droplet generation device is an electrospray device, the electrospray device has an electrospray probe; the aqueous solution is injected into the electrospray probe at a flow rate of 5 to 150 μL/min; the electrospray probe has an inner diameter of 5 to 150 μm, and a bias voltage of 3 to 7 kV is applied at the electrospray probe.

6. The method according to claim 1, wherein the S4 of collecting the hydrogen or the hydrogen radicals comprises:
arranging a collection device at a spray end of the micro-droplet generation device, wherein the collection device has a closed collection chamber and an outlet pipeline communicated with the collection chamber; and
the spray end of the micro-droplet generation device extending into the collection chamber to enable the generated hydrogen to flow through the collection chamber to enter the outlet pipeline.

7. The method according to claim 6, wherein a refrigerant is arranged at an outside of the collection chamber to cool and solidify water formed during a spraying process; and the refrigerant is one or more of: liquid nitrogen, ice water, ice-containing saline and ethylene glycol.

8. The method according to claim 6, wherein a conductive polymer plate is arranged inside the collection chamber; the conductive polymer plate is grounded or connected to a high voltage, a polarity of the high voltage is opposite to a voltage applied to the micro-droplet generation device.

9. The method according to claim 6, wherein the collection chamber is connected with to an inlet pipeline, a carrier gas is input to the collection chamber through the inlet pipeline to drive the generated hydrogen to be output from the outlet pipeline.

10. The method according to claim 1, wherein the S4 of collecting the hydrogen or the hydrogen radicals comprises:
arranging a radical capturing device at a spray end of the micro-droplet generation device, the radical capturing device outputting large droplets having a composition containing a radical capturing agent; and
applying a voltage, which has an opposite polarity to a voltage applied to the micro-droplet generation device, at an output end of the radical capturing device to cause the micro-droplets to move towards the large droplets to capture the hydrogen radicals generated from the micro-droplets.
